(19) United States
(12) Patent Application Publication
(10) Pub. No.: US 2009/0319471 A1
(43) Pub. Date: Dec. 24, 2009

(54) FIELD MAPPING FOR DATA STREAM OUTPUT

(75) Inventor: Jim Gooder, Port Orchard, WA (US)

Correspondence Address: MICROSOFT CORPORATION, ONE MICROSOFT WAY, REDMOND, WA, 98052, US

(73) Assignee: MICROSOFT CORPORATION, Redmond, WA (US)

(21) Appl. No.: 12/142,823

(22) Filed: Jun. 20, 2008

(51) Int. Cl. G06F 17/30; G06F 3/048

(52) U.S. Cl. 707/1; 715/810; 707/100; 707/E17.005; 707/E17.001

(57) ABSTRACT

A method for configuring data stream output. The method includes presenting a user interface for selecting one or more data fields from a first data source and receiving a selected data field of the first data source. An output tag corresponding to a mapping of the selected data field for an output stream is received. A second data source may be configured with the selected field and the output tag for use in data stream output.

### BACKGROUND

The widespread use and rapid development of the computer technology has allowed exchanging and sharing of large amounts of disparate information. The ability to organize the disparate information in useful way has become increasingly important.

Accordingly, a user or business may wish to have output from multiple disparate databases each having discrete fields into a common format in order to make use of the information. Conventionally, when a user wished to change the output format or add new databases a developer was needed to write a new script or interface to move data from the data fields into the common format. For example, each new field to be added to the output would require a database query to be written specifically for that data field. Unfortunately, this changing or adding of new data is time consuming as well as expensive as developers are needed for each change.

Thus, what is needed is a way to change output formats without requiring developer involvement.

### SUMMARY

This summary is provided to introduce a selection of concepts in a simplified form that are further described below in the Detailed Description. This summary is not intended to identify key features or essential features of the claimed subject matter, nor is it intended to be used to limit the scope of the claimed subject matter.

Described herein is technology for, among other things, configuring an output data stream. It involves various techniques for accessing and selecting data fields from a variety of data sources and corresponding mappings for output of the data in the data fields to an output data stream. Further, the technology facilitates updates of the output data stream upon changes to the output data stream configuration and changes to the content sources. Therefore, the technology allows users to create and maintain output data streams without developer involvement.

In one implementation, a method for configuring data stream output may be used maintain an output data stream. A user interface may be presented for selecting one or more data fields from a first data source (e.g., database) and receiving a selected data field of the first data source. An output tag (e.g., XML tag) corresponding to a mapping of the selected data field for an output stream is received. A second data source (e.g., translation or mapping database) may be configured with the selected field and the output tag for use in data stream output. Thus, an output data stream may be configured and updated via a user interface by non-developers.

Techniques described herein provide a way for mapping data fields from one or more sources for output to a data stream. Thus, users are able easily and quickly update the output stream independent of developers.

### BRIEF DESCRIPTION OF THE DRAWINGS

The accompanying drawings, which are incorporated in and form a part of this specification, illustrate embodiments and, together with the description, serve to explain their principles:

FIG. 1 is a block diagram of an exemplary data flow, in accordance with an embodiment.

FIG. 2 is a block diagram of an exemplary system for outputting a data stream, in accordance with an embodiment.

FIG. 3 is a flowchart of an exemplary process for configuring data stream output, in accordance with an embodiment.

FIG. 4 is a flowchart of an exemplary process for outputting a data steam, in accordance with an embodiment.

FIG. 5 is a block diagram of an exemplary computing system environment for implementing an embodiment.

### DETAILED DESCRIPTION

Reference will now be made in detail to the embodiments of the claimed subject matter, examples of which are illustrated in the accompanying drawings. While the invention will be described in conjunction with the embodiments, it will be understood that they are not intended to limit the claimed subject matter to these embodiments. On the contrary, the claimed subject matter is intended to cover alternatives, modifications and equivalents, which may be included within the spirit and scope of the claimed subject matter as defined by the claims. Furthermore, in the detailed description of the present invention, numerous specific details are set forth in order to provide a thorough understanding of the claimed subject matter. However, it will be obvious to one of ordinary skill in the art that the claimed subject matter may be practiced without these specific details. In other instances, well known methods, procedures, components, and circuits have not been described in detail so as not to unnecessarily obscure aspects of the claimed subject matter.

Some portions of the detailed descriptions that follow are presented in terms of procedures, logic blocks, processing, and other symbolic representations of operations on data bits within a computer or digital system memory. These descriptions and representations are the means used by those skilled in the data processing arts to most effectively convey the substance of their work to others skilled in the art. A procedure, logic block, process, etc., is herein, and generally, conceived to be a self-consistent sequence of steps or instructions leading to a desired result. The steps are those requiring physical manipulations of physical quantities. Usually, though not necessarily, these physical manipulations take the form of electrical or magnetic signals capable of being stored, transferred, combined, compared, and otherwise manipulated in a computer system or similar electronic computing device. For reasons of convenience, and with reference to common usage, these signals are referred to as bits, values, elements, symbols, characters, terms, numbers, or the like with reference to the claimed subject matter.

It should be borne in mind, however, that all of these terms are to be interpreted as referencing physical manipulations and quantities and are merely convenient labels and are to be interpreted further in view of terms commonly used in the art. Unless specifically stated otherwise as apparent from the discussion herein, it is understood that throughout discussions of the present embodiment, discussions utilizing terms such as “determining” or “outputting” or “transmitting” or “recording” or “locating” or “storing” or “displaying” or “receiving” or “recognizing” or “utilizing” or “generating” or “providing” or “accessing” or “checking” or “notifying” or “delivering” or the like, refer to the action and processes of a computer system, or similar electronic computing device, that manipulates and transforms data. The data is represented as physical (electronic) quantities within the computer system's registers and memories and is transformed into other data similarly represented as physical quantities within the computer system memories or registers or other such information storage, transmission, or display devices.

### Overview

Described herein is technology for, among other things, configuring an output data stream. It involves various techniques for accessing and selecting data fields from a variety of data sources and corresponding mappings for output of the data in the data fields to an output data stream. Further, the technology facilitates updates of the output data stream upon changes to the output data stream configuration and changes to the content sources. Therefore, the technology allows users to create and maintain output data streams without developer involvement.

In one implementation, a method for configuring data stream output may be used maintain an output data stream. A user interface may be presented for selecting one or more data fields from a first data source (e.g., database) and receiving a selected data field of the first data source. An output tag (e.g., XML tag) corresponding to a mapping of the selected data field for an output stream is received. A second data source (e.g., translation or mapping database) may be configured with the selected field and the output tag for use in data stream output. Thus, an output data stream may be configured and updated via a user interface by non-developers.

Techniques described herein provide a way for mapping data fields from one or more sources for output to a data stream. Thus, users are able easily and quickly update the output stream independent of developers.

### Example Data Flow

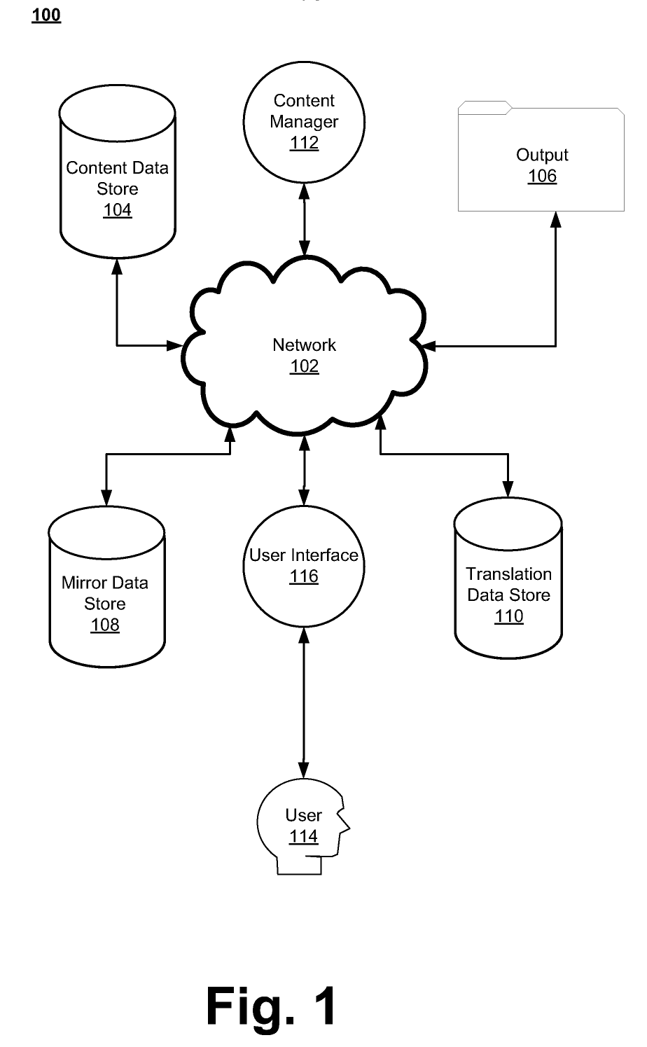

FIG. 1 shows an exemplary data flow, in accordance with an embodiment.

Data flow diagram 100 includes network 102, content data store 104, output 106, mirror data store 108, translation data store 110, content manager 112, user interface 116, and user 1 14. Content data store 104, mirror data store 108, and translation data store 110 may be a variety of information storage and retrieval systems including, but not limited to, databases (e.g., SQL databases), knowledge bases, and the like.

Network 102 may be any of a variety of networks including, but not limited to, local area networks, or the Internet.

User interface 116 allows user 114 to define and/or configure mapping tables and stored procedures stored in translation data store 110. User interface 116 may allow a user to configure mapping tables of translation data store 110 to be used to map data fields (e.g., database fields or XML data fields) in content data store 104 to output 106. For example, user interface 116 may allow user 114 to map data fields of a database to XML (Extensible Markup Language) tags and associated attributes (e.g., , <title name=DVD price=$20>). The mapping tables of translation data store 110 may be created via dynamic SQL.

User interface 116 can be a web interface and further allow user 114 to control updating of the output format of output 106 (e.g., an XML stream), either incrementally or as a whole. For example, user interface 116 can allow user 114 to modify the mapping data to include into new XML data types or tags for new content added to content data store 104. It is appreciated that changing or adding to mapping tables does not require user 114 to be a developer or write new queries to support the new content.

Translator data store 110 can output XML streams to output 106 in a variety of formats including, but not limited to, files or streams of data which can be feed into other systems (e.g., a data feed for a search engine or RSS (Really Simple Syndication) feed). Output 106 may be generated via dynamic SQL with content from content data store 104 and/or mirror data store 108.

Optional Mirror data store 108 can be used to manipulate or modify data from content data store 104. That is, mirror data store 108 may provide a location for data to be adapted prior to sending the data out as part of the stream. Mirror data store 108 may be configured via user interface 116 for filtering data from content data store 104. For example, SGML characters or other characters could be converted (e.g., to Unicode characters or escaped) or removed via mirror data store 108. Such filtering may be done in order to configure output 106 for use by an application (e.g., search engine). Advantageously, mirror data store 108 allows data from content data store 104 to be modified (e.g., customized for output) without impacting the data in content data store 104. For example, mirror data store 108 could thus be used to obviate the need to move data to XML format as the storage solution, since mirror data store 108 provides an easy way to have the benefits of structured storage and still be able to store information in a variety of exportable XML formats.

Translation data store 110 may thus access data in mirror data store 108 and create output streams for each entry within mirror data store 108. Once translation data store 110 has created all the data streams corresponding to each entry of data in mirror data store 108, the stream may be output as output 106.

Content manager 112 manages updates to the output 106. Content manager 112 may periodically (e.g., hourly, daily, weekly, etc.) query data in content data store 104 and determines changes (e.g., updates, additions, and deletions) that have occurred to data in content data store 104 since the last generation of output 106. Content manager 112 may then invoke generation of new output 106 via use of translation data store 110 and/or mirror data store 108. For example, content manager 112 could update RSS feeds or output 106 based on a new news article being added to the content data store 104. Content manager 112 may use mirror data store 108 to store information that has changed in content data store 104.

### Example System

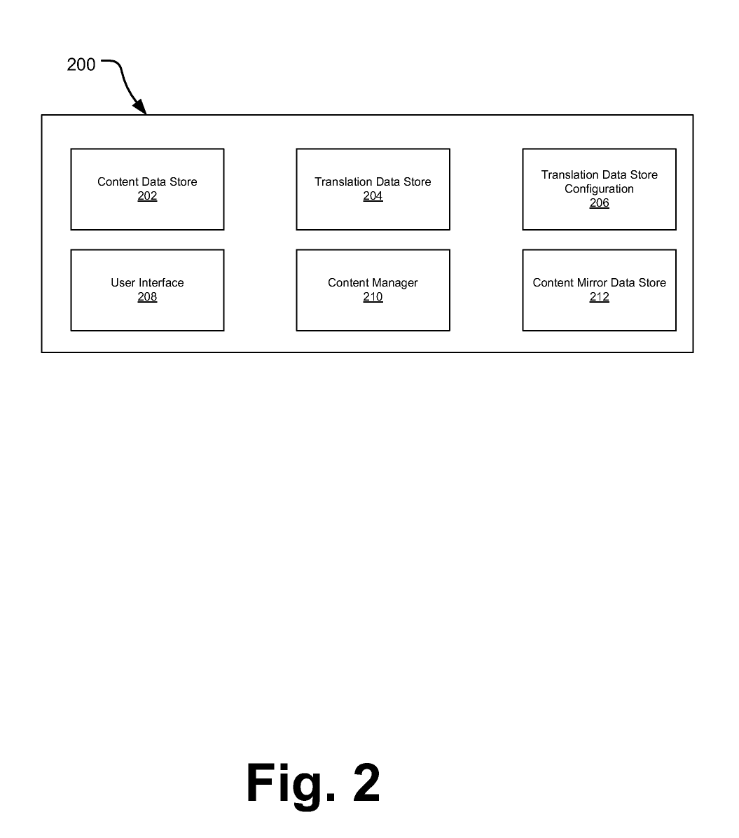

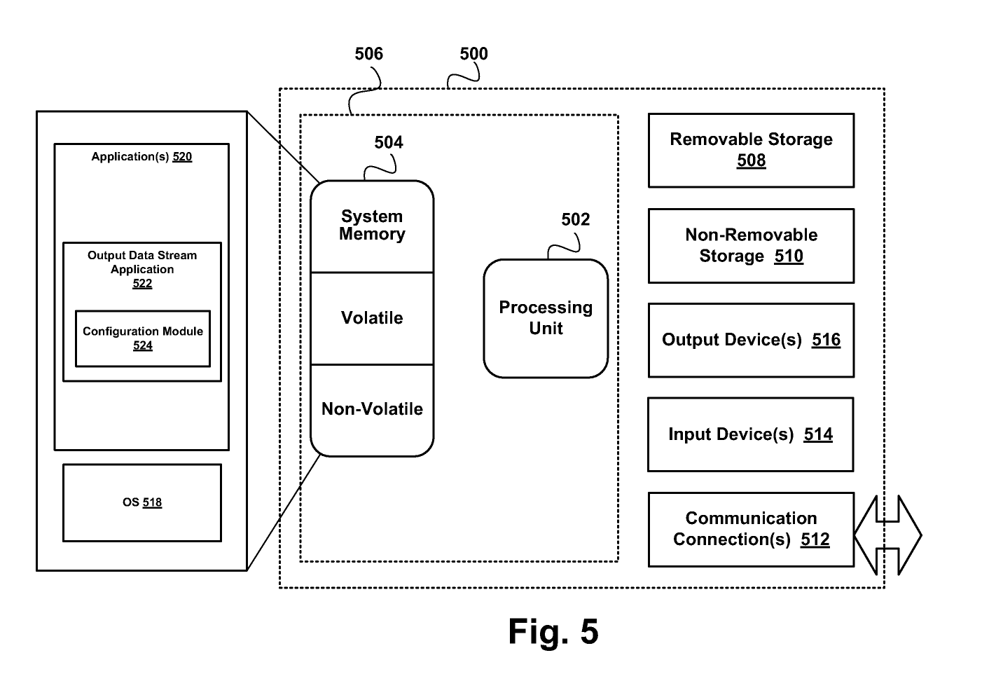

The following discussion sets forth details of the present technology systems for network communication management. FIG. 2 illustrates example components used by various embodiments of the present technology. System 200 includes components or modules that, in various embodiments, are carried out by a processor under the control of computer-readable and computer-executable instructions. The computer-readable and computer-executable instructions reside, for example, in data storage features such as computer usable memory 504, removable storage 508, and/or non-removable storage 510 of FIG. 5. The computer-readable and computer-executable instructions are used to control or operate in conjunction with, for example, processing unit 502 of FIG. 5. It should be appreciated that the aforementioned components of system 200 can be implemented in hardware or software or in a combination of both. Although specific components are disclosed in system 200 such components are examples. That is, embodiments are well suited to having various other components or variations of the components recited in system 200. It is appreciated that the components in system 200 may operate with other components than those presented, and that not all of the components of system 200 may be required to achieve the goals of system 200.

FIG. 2 shows an exemplary system for outputting a data stream, in accordance with an embodiment. System 200 includes content data store 202, translation data store 204, translation data store configuration module 206, user interface module 208, content manager module 210, and content mirror data store 212.

Content data store 202 includes at least one data field operable for output to an output data stream. Content data store 202 may be a variety of information storage and retrieval systems including, but not limited to, databases (e.g., SQL databases), knowledge bases, and the like. For example, content data store 202 may include a database field such as a title in an album table which may be output in an XML data stream (e.g., RSS feed). Further, content data store 202 may include data sources that are local or remote. The identity fields of content data store 202 can be used as primary keys, dual primary keys, or GUIDs fields can be used for identifying and link data.

Translation data store 204 stores one or more mappings of data fields to an output data stream. Translation data store be may a variety of information storage and retrieval systems including, but not limited to, databases (e.g., SQL databases), knowledge bases, and the like. In one embodiment, each record of a mapping table in translation data store 204 corresponds to the mapping of a data field to a tag of an output data stream. Translation data store 204 may further map XML tags within content data store 202 to an output data stream.

Translation data store 204 may further map multiple fields of a database to multiple tags of an XML output stream. Translation data store 204 may be operable to map a single data field of content data store 202 to a plurality of tags of the output data stream of system 200. For example, translation data store 204 may map a title data field of data store 202 to a search result and search description field in the output data stream. Similarly, translation data store 204 may be operable to map a plurality of data fields of content data store 202 to a tag of the output data stream. For example, translation data store 202 may map the title and description fields of content data store 202 to a search result tag in the output data stream.

User interface module 208 facilitates configuration of the translation data store 204. For example, a user interface presented via user interface module 208 may allow a definition of an XML format including, but not limited to, tag, attributes, and the actual content of the XML tag (e.g., data in a database field). It is appreciated that user interface module 208 may present a user interface for use by content managers and other non developers and thereby allow configuration of an output stream without developer involvement. The user interface presented via user interface module 208 may be operable to be displayed by a web browser or other application (e.g., desktop application).

Translation data store configuration module 206 is operable to configure the translation data store 204. Based on input received via user interface module 208, the mapping tables of translation data store 204 may be then be generated or configured. In one embodiment, the associated dynamic SQL and/or associated stored procedures calls to map the database fields for stream output are stored in the mapping tables of translation data store 204. For example, each record of the mapping tables of translation data store 204 may include a table name, a field of that table, and an XML tag and corresponding attributes for output.

Content manager module 210 facilitates updates to the output data stream. Content manager module 210 may determine data of content data store 202 that has changed (e.g., updates, additions, or deletions) and then invoke an update to the output stream of system 200. Content manager module 210 may also invoke updates to the output of system 200 based on receiving notifications based on tracking methods of remote systems (e.g., remote systems hosting databases). The content manager module 210 may perform methods or algorithms for determining which streams (e.g., XML streams) have been added, change or deleted to the output stream of system 200. For example, when the mapping tables of translation data store 204 are modified, content manager module 210 may invoke regeneration of output of content affected by the change.

Content manager module 210 may further store changed data of content data store 202 in content mirror data store 212. Content mirror data store 212 is further operable to stored filtered or converted data, as described herein, from content data store 202. Content data mirror 212 may also be used to store remote data locally for use by translation data store 204.

### Example Operations

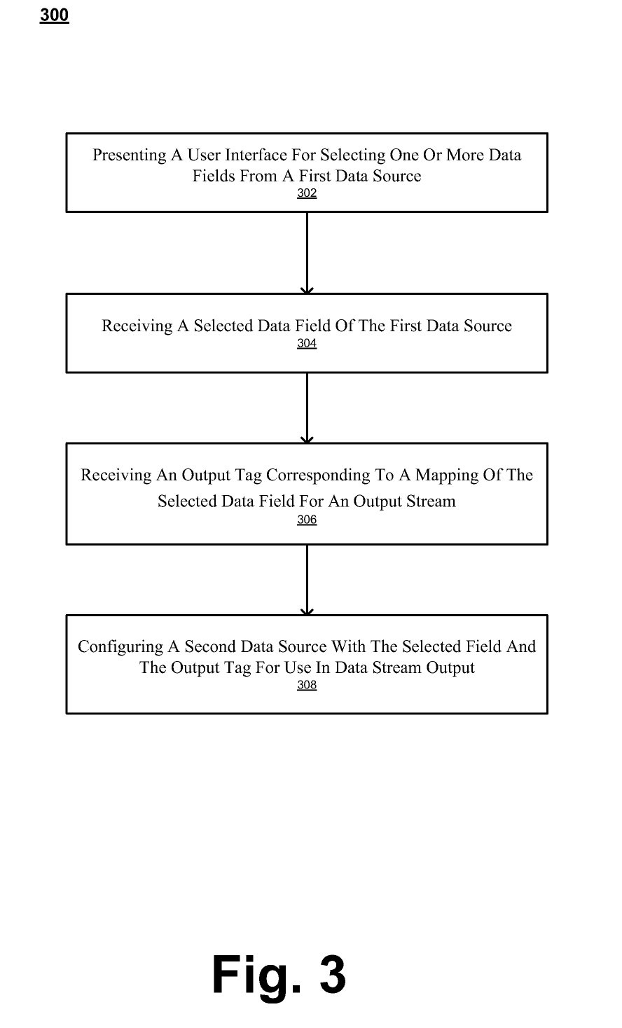

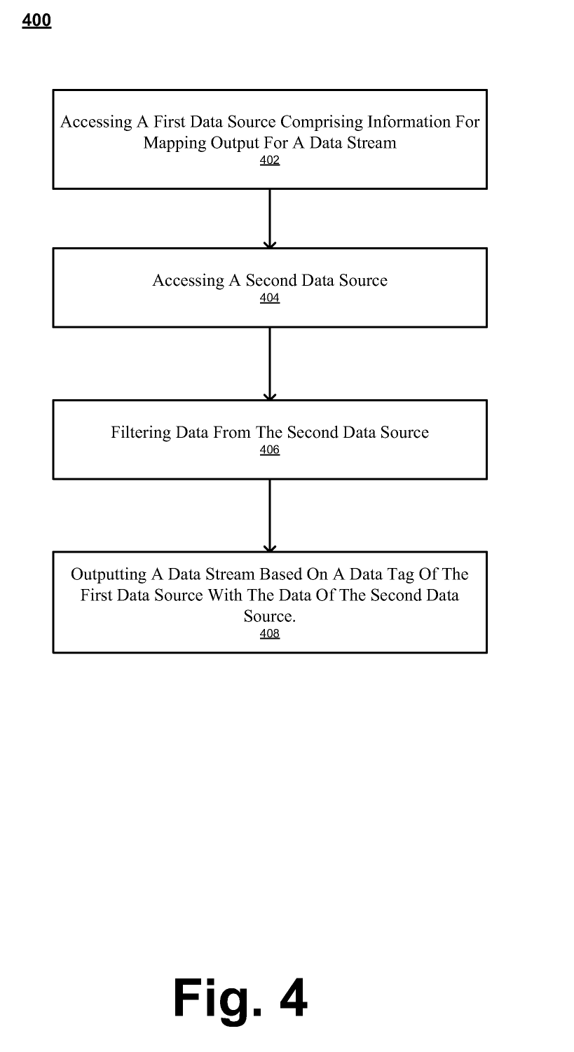

The following discussion sets forth in detail the operations of the present technology for data stream output. With reference to FIGS. 3 and 4, flowcharts 300 and 400 each illustrate example blocks used by various embodiments of the present technology. Flowcharts 300 and 400 include processes that, in various embodiments, are carried out by a processor under the control of computer-readable and computer-executable instructions.

FIG. 3 is a flowchart 300 of an exemplary process for configuring data stream output, in accordance with an embodiment. The process of flowchart 300 may be carried out by a system (e.g., system 500) and be carried out in conjunction with a graphical user interface. The graphical user interface used in conjunction with flowchart 300 may be presented via a variety of applications including, but not limited to, web browser or a local executing application (e.g., desktop client software).

At block 302, a user interface is presented (e.g., via user interface module 208) for selecting one or more data fields from a first data source (e.g., content data store 202). The first data source may be one or more databases which may be partitioned across multiple servers which may be local or remote. The databases may further contain data in XML format. An XML query language can be used that allows each tag within the XML to be treated as a data field.

At block 304, a selected data field of the first data source is received. As described herein, the selected data field may be a field of a database to be mapped to an output stream.

At block 306, an output tag corresponding to a mapping of the selected data field for an output stream is received. As described herein, the output tag may be a XML tag which may include one or more attributes.

At block 308, a second data source (e.g., translation data store 204) is configured with the selected field and the output tag for use in data stream output. The data stream output may be operable for use as an RSS feed (e.g., in an XML format). The data stream output may also be operable for use with a search engine.

For example, an e-commerce site may sell a wide variety of products and therefore have many different types of content in a catalog database having fields including title, description, cost, author, and seller. An XML stream may needed to be generated to feed the catalog data to a search engine.

A content manager may first define an XML format for which the search engine requires and then setup the various XML tag formats to feed to the search engine. The search engine may require one XML tag for universally identifying a piece of content (e.g., what it is and what the identifies it), a second XML tag which is the searchable text which the search engine will search (e.g., keywords, metadata, description), and a third XML tag which is what the search engine will return for display after a search. There may be higher priority and lower priority search XML in the XML format for search engine.

Once the xml layout is determined and implemented, a content manager can add to or modify the output of the content by populating mapping tables set up for the specific XML tags. For example, the title field could be mapped to the searchable part of XML (e.g., the second XML tag). The title field could also be mapped to the results part of the XML (e.g., the third XML tag).

If a content manager wanted to add new table called albums, the content manager would be able to select the new table and the corresponding data fields to map to the appropriate parts of the XML output data stream for use by the search engine in a manner substantially similar to that used to setup the output data stream.

FIG. 4 is a flowchart 400 of an exemplary process for outputting a data stream, in accordance with an embodiment. At block 402, a first data source is accessed. The first data source may include information for mapping output for a data stream. As described in herein, the mapping may comprise a data field identifier and a corresponding data tag for an output data stream.

At block 404, a second data source is accessed. As described herein, the second data source may be a database including the data field mapped in the first data source and data corresponding to the data field. For example, second data source may be a database of books with a title field.

At block 406, data from the second data source is optionally filtered. The filtering may include a variety of types of data modification including, but not limited to, converting SGML characters to Unicode characters, filtering offensive content (e.g., offensive language, images, and video), or escaping characters of data from the second data source. It is appreciated that the filtering described herein is not intended to be limiting and additional modification of data may be performed.

At block 408, a data stream is output based on the data tag of the first data source with the data of the second data source as described herein. For example, an XML title tag and associated attributes may be output with the corresponding data from a books database.

### Example Operating Environments

With reference to FIG. 5, an exemplary system for implementing embodiments includes a general purpose computing system environment, such as computing system environment 500. Computing system environment 500 may include, but is not limited to, servers, desktop computers, laptops, tablet PCs, mobile devices, and smartphones. In its most basic configuration, computing system environment 500 typically includes at least one processing unit 502 and memory 504. Depending on the exact configuration and type of computing system environment, memory 504 may be volatile (such as RAM), non-volatile (such as ROM, flash memory, etc.) or some combination of the two. This most basic configuration is illustrated in FIG. 1 by dashed line 506.

System memory 504 may include, among other things, operating system 518 (OS), application(s) 520, and output data stream application 522. Output data stream application 522 may facilitate mapping of data source fields to an output stream. Output data stream application 522 may further include configuration module 524. Configuration module 524 facilitates customization of the output data stream. For example, a content manager may use the configuration module 524 of output data stream application to setup and maintain an XML output data stream for a search engine or RSS feed.

Additionally, computing system environment 500 may also have additional features/functionality. For example, computing system environment 500 may also include additional storage (removable and/or non-removable) including, but not limited to, magnetic or optical disks or tape. Such additional storage is illustrated in FIG. 1 by removable storage 508 and non-removable storage 510. Computer storage media includes volatile and nonvolatile, removable and non-removable media implemented in any method or technology for storage of information such as computer readable instructions, data structures, program modules or other data. Memory 504, removable storage 508 and nonremovable storage 510 are all examples of computer storage media. Computer storage media includes, but is not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can be accessed by computing system environment 500. Any such computer storage media may be part of computing system environment 500.

Computing system environment 500 may also contain communications connection(s) 512 that allow it to communicate with other devices. Communications connection(s) 512 is an example of communication media. Communication media typically embodies computer readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. The term computer readable media as used herein includes both storage media and communication media.

Communications connection(s) 512 may allow computing system environment 500 to communication over various networks types including, but not limited to, Bluetooth, Ethernet, Wi-fi, Infrared Data Association (IrDA), Local area networks (LAN), Wireless Local area networks (WLAN), wide area networks (WAN) such as the internet, serial, and universal serial bus (USB). It is appreciated the various network types that communication connection(s) 512 connect to may run a plurality of network protocols including, but not limited to, transmission control protocol (TCP), internet protocol (IP), real-time transport protocol (RTP), real-time transport control protocol (RTCP), file transfer protocol (FTP), and hypertext transfer protocol (HTTP).

Computing system environment 500 may also have input device(s) 514 such as a keyboard, mouse, pen, voice input device, touch input device, remote control, etc. Output device(s) 516 such as a display, speakers, etc. may also be included. All these devices are well known in the art and need not be discussed at length here.

The previous description of the disclosed embodiments is provided to enable any person skilled in the art to make or use the present invention. Various modifications to these embodiments will be readily apparent to those skilled in the art, and the generic principles defined herein may be applied to other embodiments without departing from the spirit or scope of the invention. Thus, the present invention is not intended to be limited to the embodiments shown herein but is to be accorded the widest scope consistent with the principles and novel features disclosed herein.

What is claimed is:

1. A method for configuring data stream output comprising:
presenting a user interface for selecting one or more data fields from a first data source;
receiving a selected data field of said first data source;
receiving an output tag corresponding to a mapping of said selected data field for an output stream; and
configuring a second data source with said selected field and said output tag for use in data stream output.

2. The method as recited in claim 1 wherein said output tag is an XML tag.

3. The method as recited in claim 1 wherein said output tag comprises an attribute.

4. The method as recited in claim 1 wherein said first data source comprises XML streams.

5. The method as recited in claim 1 wherein said user interface is operable to be displayed via a web browser.

6. The method as recited in claim 1 wherein said first data source comprises one or more databases.

7. The method as recited in claim 1 wherein said data stream output is operable for use as an RSS feed.

8. The method as recited in claim 1 wherein said data stream output is operable for use with a search engine.

9. An apparatus for outputting a data stream comprising:
a content data store comprising at least one data field operable for output to an output data stream;
a translation data store for storing a mapping of a data field to an output data stream;
a translation data store configuration module for configuring said translation data store; and
a user interface module for facilitating configuration of said translation data store.

10. The apparatus as recited in claim 9 further comprising:
a content manager for facilitating updates to said output data stream.

11. The apparatus as recited in claim 10 wherein said content manager determines data of said content data store that has changed.

12. The apparatus as recited in claim 9 further comprising:
a content mirror data store operable to stored filtered data from said content data store.

13. The apparatus as recited in claim 12 wherein content mirror data store is operable to store changed data from said content data store.

14. The apparatus as recited in claim 9 wherein said translation data store is operable to map a data field of said content data store to a plurality of tags of said output data stream.

15. The apparatus as recited in claim 9 wherein said translation data store is operable to map a plurality of data fields of said content data store to a tag of said output data stream.

16. A method for outputting a data stream comprising:
accessing a first data source comprising information for mapping output for a data stream, wherein said mapping comprises an a data field identifier and a corresponding data tag;
accessing a second data source wherein said second data source comprises said data field and data corresponding to said data field; and
outputting a data stream based on said data tag of said first data source with said data of said second data source.

17. The method of claim 16 further comprising:
filtering data from said second data source.

18. The method of claim 16 wherein said filtering comprises converting SGML characters to Unicode characters.

19. The method of claim 16 wherein said filtering comprises filtering data from said second data source based on offensive content.

20. The method of claim 16 wherein said filtering comprises escaping characters of data from said second data source.
